(19) United States
(12) Patent Application Publication
(10) Pub. No.: US 2019/0184892 A1
(43) Pub. Date: Jun. 20, 2019

(54) VEHICLE SIGNALING APPARATUS

(71) Applicants: Timothy J. McCormack, Clinton Corners, NY (US); James D. Miller, Wyckoff, NJ (US)

(72) Inventors: Timothy J. McCormack, Clinton Corners, NY (US); James D. Miller, Wyckoff, NJ (US)

(21) Appl. No.: 15/844,524

(22) Filed: Dec. 16, 2017

(51) Int. Cl. B60Q 1/26; A42B 3/04

(52) U.S. Cl. CPC B60Q 1/2676; B62J 2006/008; B60Q 2900/30; A42B 3/0453

(57) ABSTRACT

An apparatus for use by a driver of a vehicle that has turn signals and a brake signal is described. Display circuitry includes lights, and can be supported by the driver while the driver is operating the vehicle. Base circuitry is in wireless communication with the display circuitry, can detect activation of the turn signals and the brake signal, and includes movement sensors. The apparatus can activate the lights in response to activation of the turn signals and the brake signal. In addition, the base circuitry can broadcast an accident alarm in response to detection of movement of the vehicle suggestive of a traffic accident.

### FIELD OF THE INVENTION

The present invention relates generally to signaling apparatus, and, more particularly, to apparatus for use by the operators of motorcycles and the like to signal turns, braking, and alarm events.

### BACKGROUND OF THE INVENTION

A study of road accidents involving motorcycles in the United States concluded that about 75% of motorcycle accidents involve a collision with another vehicle, usually an automobile. In most of these accidents, the failure of the motorist in the automobile to see the motorcycle was a major contributing factor. H. H. Hurt et al., Motorcycle Accident Cause Factors and Identification of Countermeasures Volume I: Technical Report, National Highway Traffic Safety Administration Publication Number: NHTSA-DOT-HS-5-01160, 1981. Motorcycles are small relative to automobiles. In addition, automobile drivers are generally not as attune to recognizing and detecting motorcycles when compared to other automobiles. Lastly, motorcycles do not typically include signal indicators (i.e., turn signals and brake signals) that are as large, as high, and as visible as those found on automobiles. A frequent accident profile involves an automobile driver driving into the back of a stopped motorcycle because the automobile driver fails to notice the stationary motorcycle in his or her path of travel. Because a motorcycle provides little protection to its rider, such accidents almost always have catastrophic consequences for the rider.

Conspicuity of motorcycles is therefore a critical factor in preventing multiple vehicle accidents involving motorcycles. As a result, there is a need for apparatus that enhance the conspicuousness of motorcycles and other smaller-profile vehicles such as all-terrain vehicles (ATVs) and snowmobiles.

### SUMMARY OF THE INVENTION

Embodiments of the present invention address the above-identified needs by providing signaling apparatus for use by the operator of a motorcycle, all-terrain vehicle, snow mobile, or the like. The signaling apparatus have the advantage of providing a light array capable of providing turn and brake signals that is mountable to the helmet of the operator, aiding with conspicuity. Movement sensors are also provided that may detect theft and accident events, allowing appropriate alarms to be generated and broadcast.

Aspects of the invention are directed to an apparatus for use by a driver of a vehicle that has a left turn signal, a right turn signal, and a brake signal. The apparatus comprises display circuitry and base circuitry. The display circuitry comprises a plurality of lights, and is adapted to be supported by the driver while the driver is operating the vehicle. The base circuitry is in wireless communication with the display circuitry, is adapted to detect activation of the turn signals and the brake signal, and comprises one or more movement sensors operative to detect movement of the vehicle. The apparatus is operative to activate at least some of the plurality of lights in response to activation of the left turn signal, as well as to activate at least some of the plurality of lights in response to activation of the right turn signal. Moreover, the apparatus is further operative to activate at least some of the plurality of lights in response to activation of the brake signal. The base circuitry is operative to broadcast an accident alarm in response to detection by the one or more movement sensors of movement of the vehicle suggestive of a traffic accident

### BRIEF DESCRIPTION OF THE DRAWINGS

These and other features, aspects, and advantages of the present invention will become better understood with regard to the following description, appended claims, and accompanying drawings where:

FIG. 1 shows a perspective view of a motorcycle operator utilizing an illustrative signaling apparatus incorporating aspects of the invention while operating a motorcycle;

FIGS. 2A-2D show various exterior views of the display unit in the FIG. 1 signaling apparatus;

FIG. 3 shows a high-level block diagram of aspects of the FIG. 1 signaling apparatus, as well as an environment in which the signaling apparatus may operate;

FIG. 4 shows a block diagram of additional aspects of the motorcycle, as well as the base unit and display unit in the FIG. 1 signaling apparatus;

FIGS. 5 and 6 show block diagrams of the base microcontroller and the display microcontroller, respectively, in the FIG. 1 signaling apparatus;

FIGS. 7 and 8 show block diagrams of elements within the display communication circuitry and the base communication circuitry, respectively, of the FIG. 1 signaling apparatus;

FIG. 9 shows a block diagram of various elements within the sensor circuitry of the base unit in the FIG. 1 signaling apparatus;

FIG. 10 shows a flow diagram of turn/brake signal functions within the FIG. 1 signaling apparatus;

FIGS. 11 and 12 show illustrative screenshots from the personal computing device when utilizing an application associated with the FIG. 1 signaling apparatus; and

FIG. 13 shows a flow diagram of alarm functions within the FIG. 1 signaling apparatus.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred. For example, while the embodiments described below are focused on applications related to motorcycles, aspects of the invention are more generally applicable to any vehicle in which a significant portion of the rider is visible from the rear of the vehicle such as, but not limited to, ATVs, trikes, and snowmobiles.

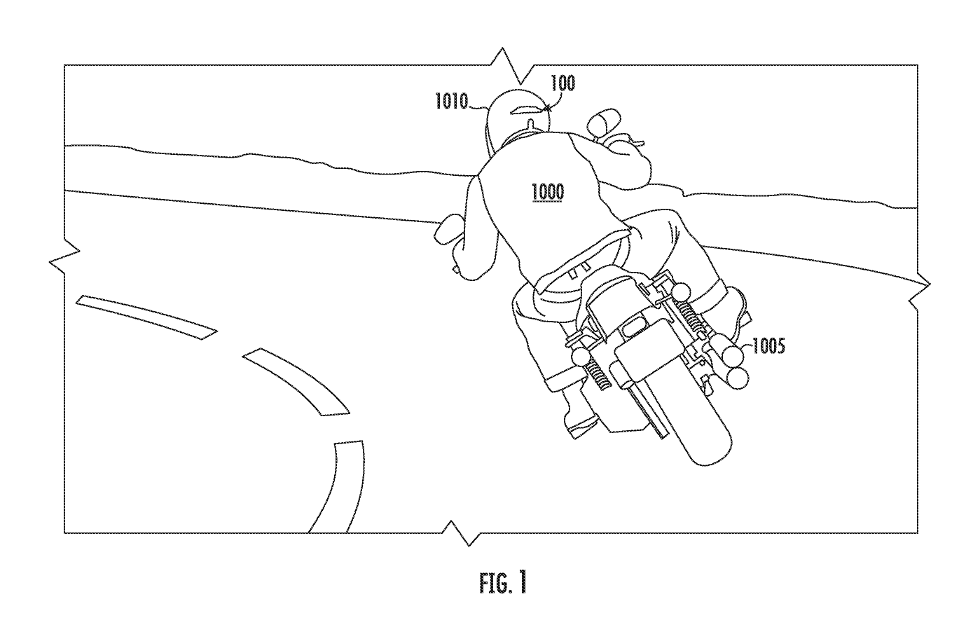

FIG. 1 shows a perspective view of a motorcycle operator (i.e., motorcycle rider 1000) utilizing an illustrative signaling apparatus 100 incorporating aspects of the invention while operating a motorcycle 1005. As will be described in detail below, circuitry within the signaling apparatus 100 detects when the motorcycle rider 1000 operates the turn signals or brakes on the motorcycle 1005, and causes a display unit 105 mounted on the motorcycle rider's helmet 1010 to produce its own corresponding light signals. At the same time, circuitry within the signaling apparatus 100 further senses movement of the motorcycle 1005. When movement suggestive of theft or a traffic accident is detected, the signaling apparatus 100 broadcasts an appropriate alarm.

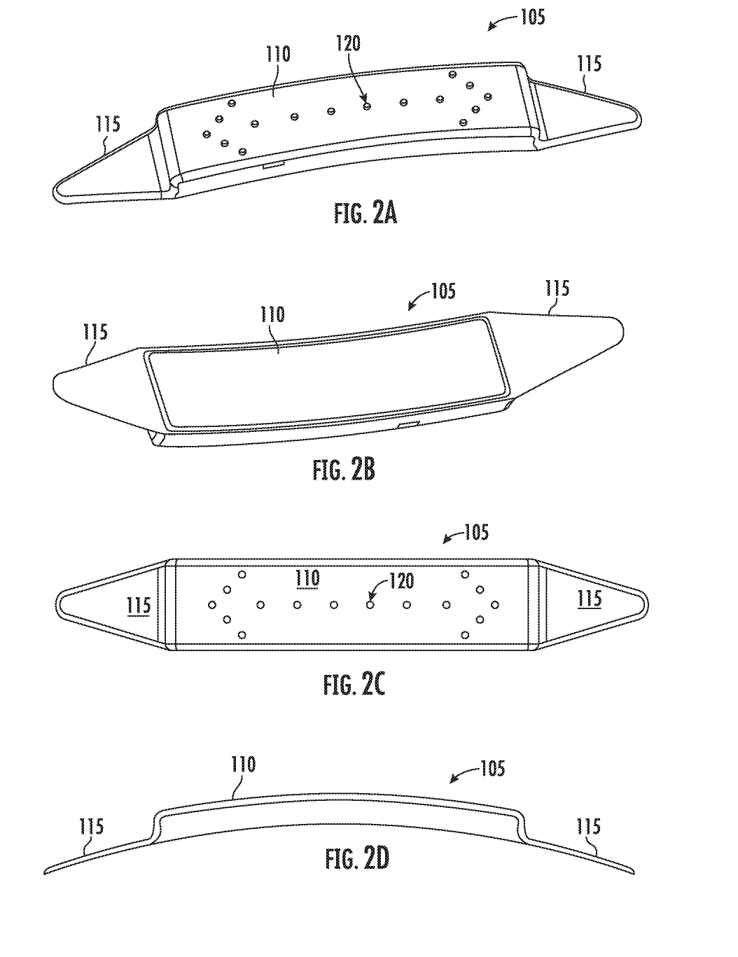

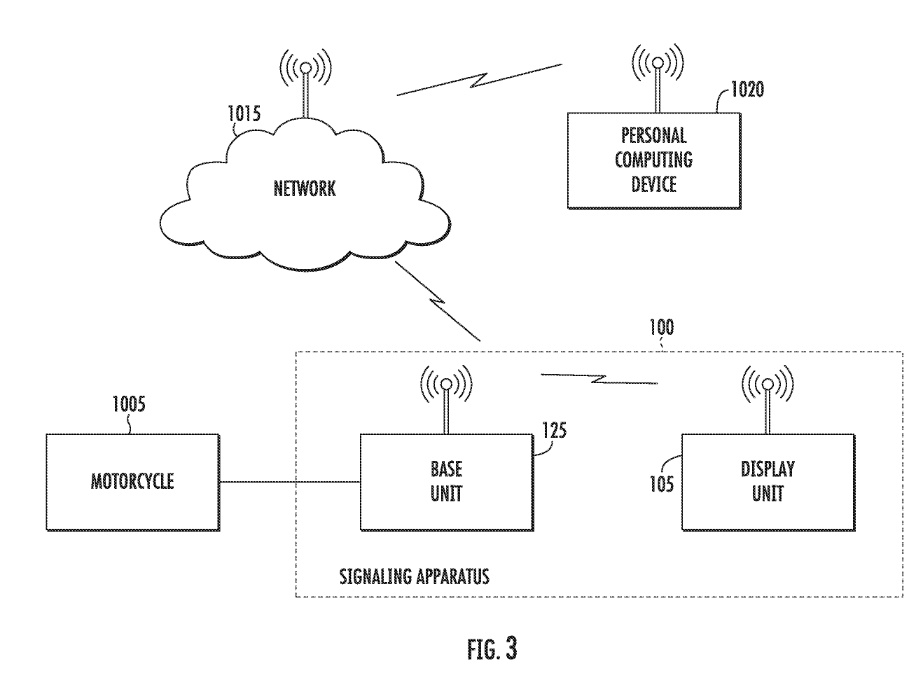

FIGS. 2A-2D show various exterior views of the display unit 105. FIG. 2A shows a front perspective view, FIG. 2B shows a rear perspective view, FIG. 2C shows a front elevational view, and FIG. 2D shows a side elevational view. The display unit 105 defines a central rectangular region 110 with two wings 115 on opposing sides thereof. The rectangular region 110 encompasses display circuitry (described below), which includes an array of light-emitting diodes (LEDs) (LED light array 120) arranged in the shape of a double-sided arrow. The LED light array 120 allows the display unit 105 to signal both turns and braking when those same signals are being operated on the motorcycle 1005.

The display unit 105 will preferably be bendable so that it may conform to the curvature of the helmet 1010. Display circuitry within the display unit 105 may, for example, be mounted on a flexible printed circuit board (PCB). The display unit's housing may likewise be somewhat flexible, being formed of an elastomeric material such as, for example, a synthetic plastic or rubber. The display circuitry may be potted to aid with water resistance and overall robustness.

The display unit 105 may be attached to the helmet 1010 of the motorcycle rider 1000 in several different ways. Attachment means include, but are not limited to, adhesives, hook-and-loop fasteners, double-sided tape, or some form of mounting hardware like a set of clips or brackets. In some embodiments, the display unit 105 may be built into the helmet 1010 itself.

FIG. 3 shows a high-level block diagram of aspects of the illustrative signaling apparatus 100, as well as an environment in which the signaling apparatus 100 may operate. The signaling apparatus 100 includes a base unit 125 (containing base circuitry) housed within the motorcycle 1005, as well as the display unit 105 (containing display circuitry) mounted on the motorcycle rider's helmet 1010. The base unit 125 is electronically connected to the motorcycle 1005. At the same time, the base unit 125 is also in wireless communication with the display unit 105 and a data network 1015, such as a cellular data network, which is connected to the internet. Finally, the network 1015 is in communication with a personal computing device 1020. As used herein and in the appended claims, a “personal computing device” may comprise any computing device capable of communicating with a data network 1015 such as the Internet (i.e., World Wide Web) including, for example, a cellular (smart) telephone, tablet computer, laptop computer, smart watch, and the like.

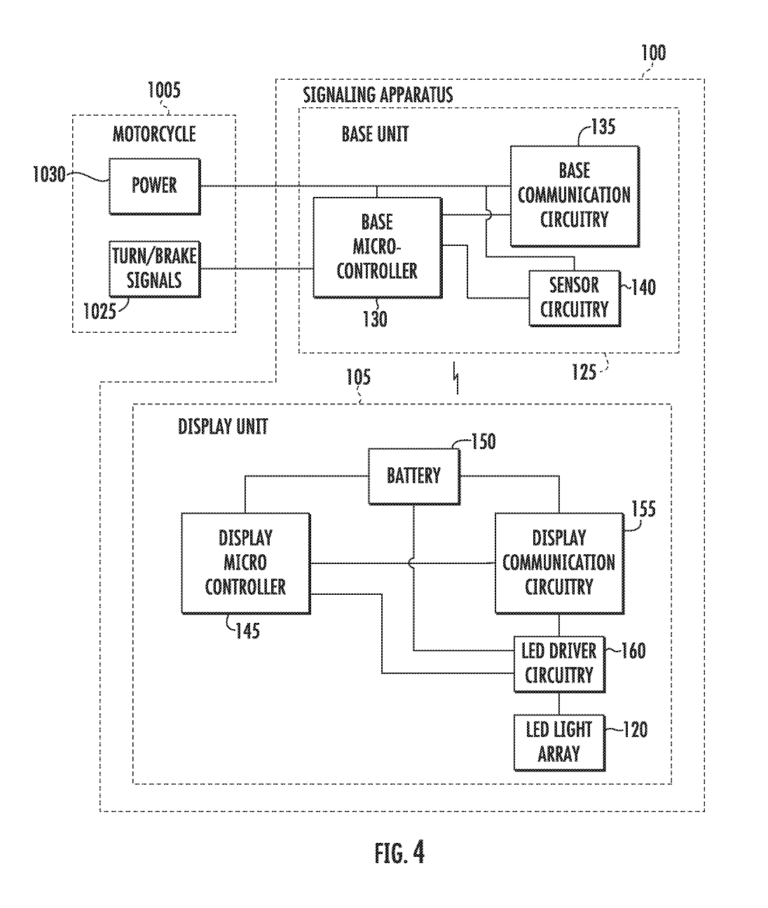

FIG. 4 shows a block diagram of additional aspects of the motorcycle 1005, base unit 125, and display unit 105. The base unit 125 comprises a base microcontroller 130, base communication circuitry 135, and sensor circuitry 140. The base microcontroller 130 is electronically connected to turn and brake signaling circuitry (turn/brake signals 1025) of the motorcycle 1005 and is thereby able to detect when those signals are activated. The base unit 125 may, for example, be housed in a box that is located under the seat of the motorcycle 1005, where the turn and brake signaling wires of the motorcycle 1005 are easily accessible. Wires connected to the base microcontroller 130 may splice into the motorcycle circuitry using, for example, solderless crimp splicers. The circuitry within the base unit 125 may, like the display unit 105, be potted.

Each of the base microcontroller 130, base communication circuitry 135, and sensor circuitry 140 is powered by the electrical system of the motorcycle 1005 (power 1030). A voltage regulator (not shown) may be included in the base unit 125 if desired. The voltage regulator may, for example, regulate the motorcycle power 1030 down to five volts direct-current power.

The display unit 105 comprises a display microcontroller 145, a battery 150, display communication circuitry 155, LED driver circuitry 160, and the LED light array 120. Here, power 1030 is from the battery 150. The battery 150 is preferably rechargeable and may comprise, for example, one or more lithium-ion battery cells. A power connection on the display unit 105 (e.g., a mini-USB plug) may facilitate access to outside power sources for charging.

Microcontrollers are regularly utilized in discrete electronics and thus their implementation will already be familiar to one having ordinary skill in the relevant arts. In addition, details of the configuration, function, and programming of microcontrollers may be found in various readily available publications including, for example, A. V. Deshmukh, Microcontrollers: Theory and Applications, Tata McGraw-Hill Education, 2005, which is hereby incorporated by reference herein. A suitable microcontroller for use as the base and display microcontrollers 130, 145, as just one example, is a MSP430 Ultra-Low Power 1030 16-Bit Microcontroller manufactured by Texas Instruments® (Dallas, Tex., USA). Nevertheless, there are myriad other choices and those alternatives would come within the scope of the invention.

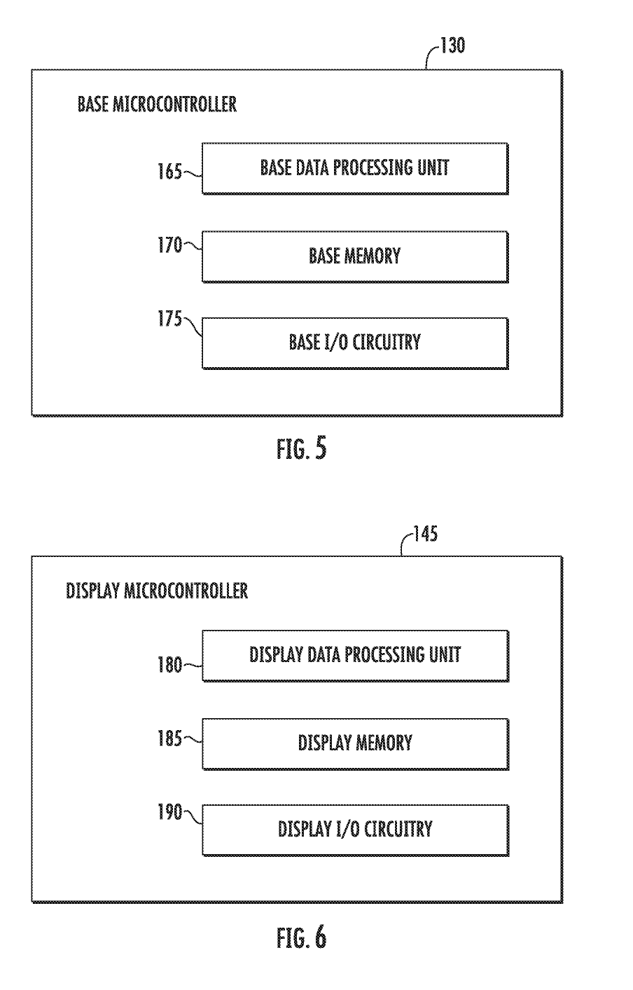

FIG. 5 shows a block diagram of the base microcontroller 130, while FIG. 6 shows a block diagram of the display microcontroller 145. The base microcontroller 130 includes a base data processing unit 165, base memory 170, and base input/output (I/O) circuitry 175. Likewise, the display microcontroller 145 includes a display data processing unit 180, display memory 185, and display I/O circuitry 190. Each of the memories 170, 185 (non-volatile and/or volatile) may store a basic input/output system (BIOS), an operating system (OS), and application programs. The application programs stored in the memories 170, 185 allow their respective data processing units 165, 180 to perform data processing, communications, and controlling functions within the base unit 125 and the display unit 105. The base I/O circuitry 175 allows the base microcontroller 130 to receive data from the motorcycle's turn/brake signals 1025, as well as to communicate with the base communication circuitry 135 and sensor circuitry 140. The display I/O circuitry 190 allows the display microcontroller 145 to communicate with the display communication circuitry 155 and the LED driver circuitry 160.

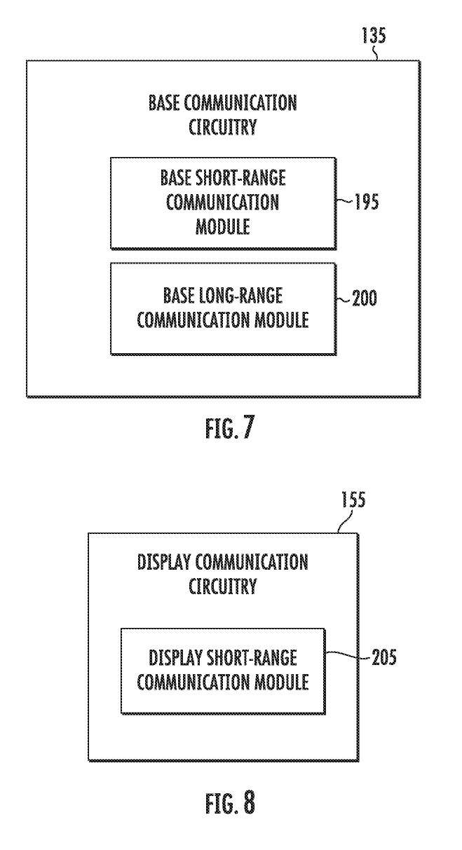

As indicated above, the base communication circuitry 135 communicates wirelessly with the display communication circuitry 155 as well as with the network 1015. FIG. 7 shows a block diagram of elements within the base communication circuitry 135, namely, a base short-range communication module 195, and a base long-range communication module 200. FIG. 8 shows a similar block diagram for the display communication circuitry 155, which comprises a display short-range communication module 205. Wireless communication between the based communication circuitry 135 and the display communication circuitry 155, intended to be over a short distance, is accomplished by the base short-range communication module 195 and the display short-range communication module 205, and may be in accordance with, for example, the Bluetooth Wireless Technology Standard. Wireless data communications with the network 1015, in contrast, is accomplished by the base long-range communication module 200, and may utilize a communications protocol that allows the base unit 125 to access one or more cellular data networks. Data communication may, for example, occur utilizing the Long-Term Evaluation (LTE) Wireless Communication Standard. A subscriber identity module (SIM) card may allow identification by the cellular network.

The LED driver circuitry 160 in the display unit 105 receives instructions from the display microcontroller 145 and controls the LED light array 120, producing turn and brake signals as appropriate. The lights of the LED light array 120 may be variously commanded to remain continuously illuminated, flash with various duty cycles and patterns, and illuminate more or less brightly.

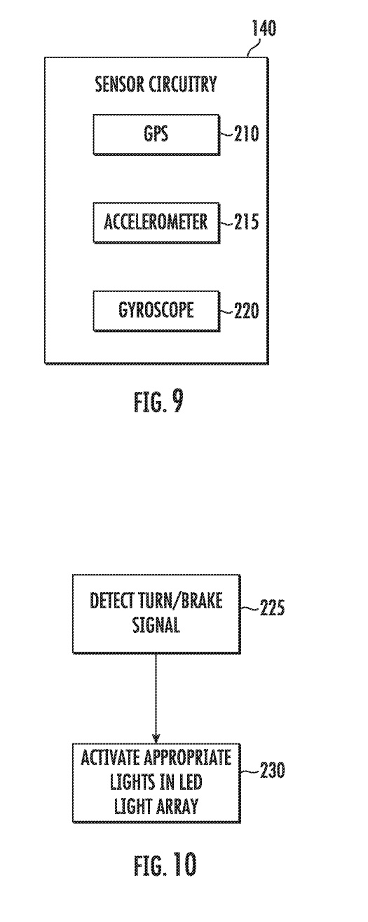

Finally, FIG. 9 shows a block diagram of various elements within the sensor circuitry 140 of the base unit 125. The sensor circuitry 140 comprises a global positioning system (GPS 210), an accelerometer 215, and a gyroscope 220. Such sensors will already be familiar to one having ordinary skill in the relevant arts, and are directed at measuring various aspects of movement. Briefly, the GPS 210 is able to determine the position of the base unit 125 as well as any movement relative thereto. The accelerometer 215 is able to detect acceleration of the base unit 125. The gyroscope 220 is able to determine orientation and angular velocity. When implemented, one or more of these sensors 210, 215, 220 may be incorporated into a single microchip or housing.

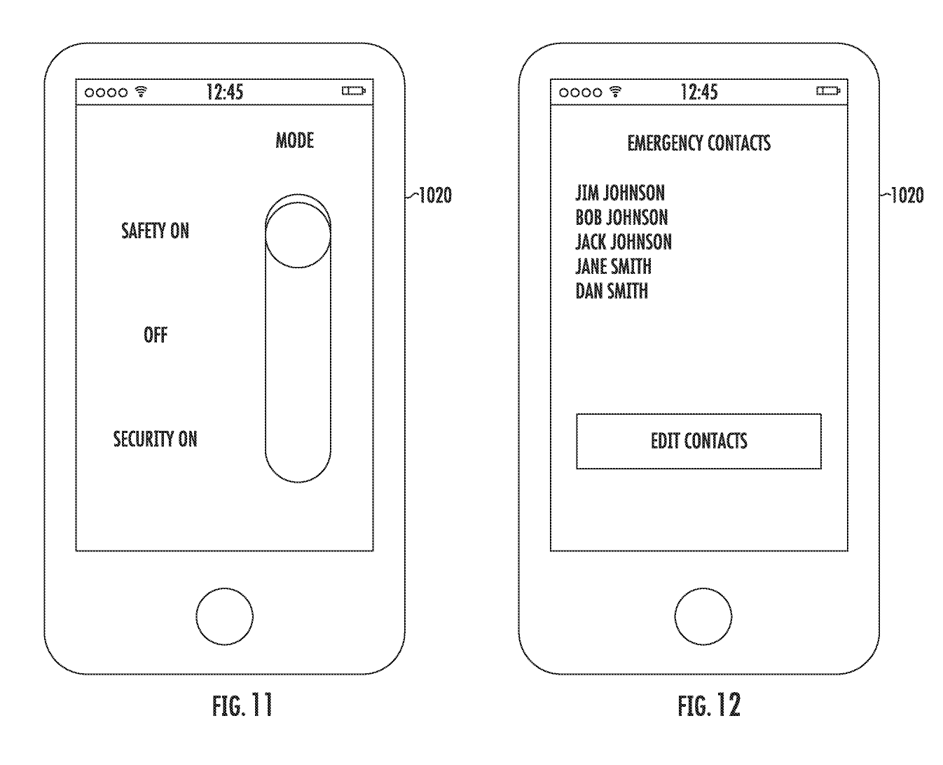

Once so configured, the signaling apparatus 100 may fulfil the various functions set forth above. FIG. 10 shows a flow diagram of the functions related to detecting and displaying turn and brake signals. In step 225, the base unit 125 monitors and detects when turn signals and brake signals are activated by the motorcycle rider 1000. These activations, in turn, are wirelessly communicated to the display unit 105, which, in step 230, activates the LED light array 120 to show the corresponding light signals. At least some of the plurality of lights in the LED light array 120 are activated when the left turn signal on the motorcycle 1005 is activated. Likewise, at least some of the plurality of lights in the LED light array 120 are activated when the right turn signal on the motorcycle 1005 is activated. Finally, at least some of the plurality of lights in the LED light array 120 are activated when the brake signal on the motorcycle 1005 is activated.

Both theft and accident alarms are facilitated by the sensor circuitry 140, which, as mentioned above, is directed at measuring various aspects of movement. The illustrative signaling apparatus 100 is able to take on three modes, a safety mode associated with detecting traffic accidents, a security mode directed at detecting unauthorized movement (e.g., theft) of the motorcycle 1005, and finally, an off-mode where no alarms are broadcast no matter what is detected. In the present illustrative embodiment, these three modes may be conveniently activated utilizing an application (often just called an “app”) running on the personal computing device 1020.

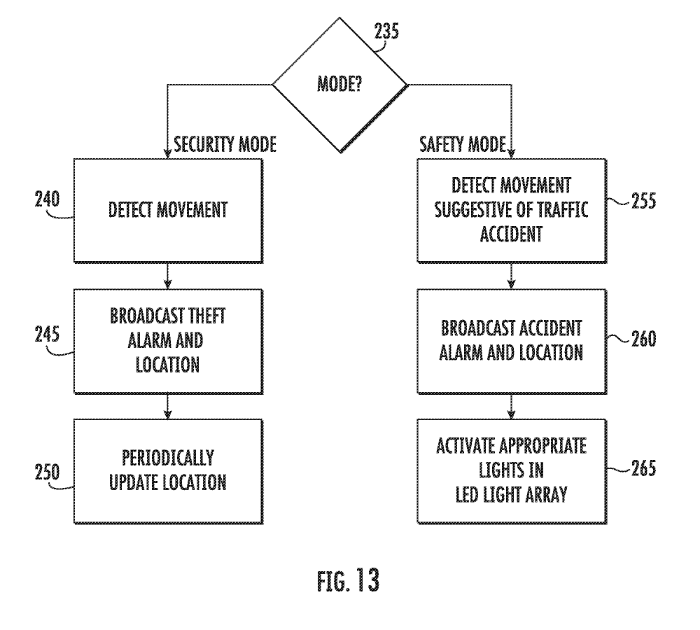

FIG. 11 shows an illustrative screenshot from the personal computing device 1020 when utilizing the app associated with the signaling apparatus 100. The app allows the user to select between activating the safety mode, security mode, and off-mode utilizing a simple slider. Once selected, the app signals the choice to the network 1015, which communicates it to the base unit 125, placing the base unit 125 in the selected mode. An additional screen of the app is shown in the screenshot set forth in FIG. 12. Here the user may enter one or more emergency contacts. Each contact may be associated with one or more respective means of contact, such as an email address, telephone number, text messaging address, etc.

FIG. 13 shows a block diagram of the function of the signaling apparatus 100 depending on the mode selected. In step 235, the base unit 125 determines which mode it is in. When in the security mode, the base unit 125 continually monitors any movement detected by the sensor circuitry 140 in step 240. If movement is detected, the base unit 125 broadcasts a theft alarm to the network 1015 in step 245, which is ultimately passed on to the personal computing device 1020. The personal computing device 1020, in turn, alerts the user of the personal computing device 1020 and sends additional alerts to the emergency contacts shown in FIG. 12. The theft alarm in step 245 preferably also includes the location of the motorcycle 1005 as determined by the GPS 210. This location is periodically updated and broadcast in step 250 so that the proper law enforcement authorities can recover the motorcycle 1005.

When in safety mode, the signaling apparatus 100 functions somewhat differently, and instead of being triggered by any movement, as was the case in the security mode, is instead continuously monitoring the sensor circuitry 140 in step 255 for movement (i.e., motion) suggestive of a traffic accident. Such movement may include movement indicating: an abrupt stop and/or an abrupt acceleration suggestive of a collision; a sudden tilting movement suggestive of the motorcycle 1005 falling over; spinning movement suggestive of the motorcycle 1005 rotating uncontrolled on the road; and the like. In each case, the data from the sensors 210, 215, 220 may be compared to an envelope of what is considered normal motion when a motorcycle is under control and in ordinary traffic conditions. When a sensor 210, 215, 220 provides data that falls outside that “normal” envelope, an accident is assumed, and the base unit 125 here again broadcasts an alarm in step 260, in this case, an accident alarm. The accident alarm is disseminated by the network 1015 and personal computing device 1020 to the various emergency contacts. The alarm in step 260 also includes the location of the motorcycle 1005, as determined by the GPS 210. Upon detection of an accident, appropriate lights in the LED light array 120 on the helmet 1010 of the motorcycle rider 1000 are also activated in step 265. The lights may be caused to, for example, flash brightly so that other traffic will be alerted to the location of the possibly-injured driver.

It is therefore contemplated that a user of the signaling apparatus 100 would place the signaling apparatus 100 in security mode when leaving the motorcycle 1005 unattended and concerned about theft, and will place the signaling apparatus 100 in safety mode when riding the motorcycle 1005 and concerned about traffic accidents. The illustrative signaling apparatus 100 thereby provides several advantages beyond the increased conspicuity provided by the display unit 105 on the rider's helmet 1010. It also provides a means of recovering a stolen motorcycle 1005, and perhaps even more importantly, a means of signaling for help if the rider 1000 is involved in an accident. In the latter case, the location of the accident is transmitted, and the proper authorities may be quickly and accurately alerted so that response time is minimized.

Once understood from the description provided above, the signaling apparatus 100 may be manufactured utilizing common manufacturing techniques that will already be familiar to one skilled in the relevant arts. Electronic components for the various circuits may be sourced commercially from, as just one example, Mouser Electronics® Inc. (Mansfield, Tex., USA).

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

For example, while a particular arrangement of circuitry is provided herein, one having ordinary skill in the electronics arts will recognize that there are several ways of accomplishing the desired functionality, and those alternative designs will also come within the scope of the invention. In some case, as an example, digital components may be replaced by analog components, if so desired.

Moreover, additional features may be added to an apparatus that falls within the scope of the present invention. In one or more embodiments, for example, an apparatus might include a transponder that communicates with other nearby vehicles or traffic signals.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in 35 U.S.C. § 112, ¶6. In particular, the use of “step of” in the claims herein is not intended to invoke the provisions of 35 U.S.C. § 112, ¶6.

1. An apparatus for use by a driver of a vehicle that has a left turn signal, a right turn signal, and a brake signal, the apparatus comprising:
display circuitry comprising a plurality of lights and adapted to be attached to a helmet; and
base circuitry electronically connected to circuitry of the vehicle and powered by the vehicle, in wireless communication with the display circuitry, adapted to detect activation of the left turn signal, the right turn signal, and the brake signal, and comprising one or more movement sensors operative to detect movement of the vehicle;
wherein the apparatus is operative to activate at least some of the plurality of lights in response to activation of the left turn signal;
wherein the apparatus is operative to activate at least some of the plurality of lights in response to activation of the right turn signal;
wherein the apparatus is operative to activate at least some of the plurality of lights in response to activation of the brake signal;
wherein the base circuitry is operative to broadcast an accident alarm in response to detection by the one or more movement sensors of movement of the vehicle suggestive of a traffic accident;
wherein the display circuitry is flexible and bends when attached to the helmet to conform to a curvature of the helmet;
wherein the base circuitry is operative to be placed into a security mode; and
wherein the base circuitry is operative to transmit a theft alarm in response to detection of movement of the vehicle by the one or more movement sensors while in the security mode.

2. The apparatus of claim 1, wherein the broadcast of the accident alarm includes data indicating of a location of the vehicle.

3. (canceled)

4. The apparatus of claim 1, wherein the apparatus is operative to be placed into the security mode utilizing a personal computing device remote to the apparatus.

5. The apparatus of claim 1, wherein the broadcast of the theft alarm includes data indicating a position of the vehicle.

6. The apparatus of claim 1, wherein the vehicle is a motorcycle.

7. (canceled)

8. (canceled)

9. The apparatus of claim 1, wherein the display circuitry comprises one or more lights in a shape of a double-sided arrow.

10. The apparatus of claim 1, wherein the plurality of lights comprise a light emitting diode.

11. The apparatus of claim 1, wherein the display circuitry is powered by one or more batteries.

12. The apparatus of claim 11, wherein the one or more batteries are rechargeable.

13. The apparatus of claim 1, wherein at least a portion of the display circuitry is potted.

14. (canceled)

15. (canceled)

16. The apparatus of claim 1, wherein the one or more movement sensors comprise an accelerometer.

17. The apparatus of claim 1, wherein the one or more movement sensors comprise a global positioning system.

18. The apparatus of claim 1, wherein the one or more movement sensors comprise a gyroscope.

19. The apparatus of claim 1, wherein the base circuitry is operative to communicate with a data network.

20. The apparatus of claim 1, wherein at least a portion of the base circuitry is potted.
